(19) United States
(12) Patent Application Publication
(10) Pub. No.: US 2015/0372432 A1
(43) Pub. Date: Dec. 24, 2015

(54) CONNECTION MODULE WITH LIGHT DISPLAY

(71) Applicant: PHOENIX CONTACT GmbH & Co KG, Blomberg (DE)

(72) Inventors: Willi HAGEMEIER, Schieder-Schwalenberg (DE); Falk LANGER, Zwoenitz (DE)

(73) Assignee: PHOENIX CONTACT GmbH & Co KG, Blomberg (DE)

(21) Appl. No.: 14/764,660

(22) PCT Filed: Jan. 14, 2014
(86) PCT No.: PCT/EP2014/050578

§ 371 Date: Jul. 30, 2015

(30) Foreign Application Priority Data
Jan. 31, 2013 (DE) 10 2013 100 987.5

(51) Int. Cl. H01R 13/717; H01R 27/02

(52) U.S. Cl. CPC H01R 13/7175; H01R 27/02

(57) ABSTRACT

The disclosure relates to a connection module, including a plurality of connections for functional elements and a plurality of operating indicators. At least one of the operating indicators has a display element, and the display element has a base, which is disposed as a light guide and which has a light in-coupling surface and a light out-coupling surface.

The invention relates to a connection module with a plurality of connections for functional elements and with a plurality of operating indicators.

Connection modules such as this are used in order to achieve machine-oriented signal acquisition in an automation installation. Connection modules such as this enable installation and service costs to be reduced since control cabinets and conductor materials can be saved, and commercially available plug-in connectors enable simple and reliable connection. The operating indicators of connection modules such as this enable it to be easily checked whether signals are present at the respective connections of the connection module. However, separate operating indicators with light sources are necessary for this purpose, which operating indicators are arranged in the vicinity of the connections in order to enable simple and intuitive assignment of an operating indicator to a connection. This leads to a complicated design of such connection modules.

The object of the present invention is therefore to provide a connection module with a simplified design.

This object is achieved by the subject matter having the features according to the independent claims. Advantageous embodiments are the subject matter of the dependent claims, the description and the drawing.

The present invention is based on the knowledge that the design of such a connection module is simplified by the use of a light guide.

According to a first aspect, the problem is solved in that at least one of the operating indicators has a display element, and in that the display element has a base body which is configured as a light guide and which has a light in-coupling surface and a light out-coupling surface. This results in the technical advantage that light signals from a light source can be forwarded, wherein the light source is arranged so as to be remote from the display element. As a result, the design of the connection module is simplified.

In an advantageous embodiment, the display element has a labeling field element. This results in the technical advantage that information about the functional element connected to the connection is provided by means of the labeling field element, for example by a particular color configuration of the labeling field element, for example green for sensor and blue for actuator. Thus, simple and rapid assignment is possible when checking the functionality of the automation installation.

In another advantageous embodiment, the labeling field element has a labeling field light in-coupling surface and the labeling field light in-coupling surface is in light-conductive contact with the light out-coupling surface. This results in the technical advantage that light signals from the light out-coupling surface can be coupled into the labeling field element and then coupled out, with the result that the labeling field element itself is illuminated and the information of the labeling field element is available without the aid of additional illumination means.

In another advantageous embodiment, the labeling field element has a labeling. This results in the technical advantage that further information regarding the functional elements connected to the connection module is available. In this case, the labeling can be configured to be clear, white or colored in order to ensure particularly simple recognizability, for example by contrast.

In another advantageous embodiment, the labeling field element has a guide section which is in engagement with a guide of the base body. This results in the technical advantage that the labeling field element is securely mounted on the base body but can be separated from the base body by a displacement of the guide section in the guide and optionally exchanged or provided with another labeling if another function module is connected to a connection. Thus, the manageability of the connection module is improved.

In another advantageous embodiment, the guide section and the guide define a first mounting direction for mounting the labeling field element on the base body, wherein the first mounting direction differs from a second mounting direction for mounting the display element on the connection module. This results in the technical advantage that the connection module has a particularly simple design.

In another advantageous embodiment, the first mounting direction and the second mounting direction are arranged at right angles to one another. As a result of this, the design of the connection module is once again simplified.

In another advantageous embodiment, the base body has a base section with the light out-coupling surface and two arm sections which adjoin the base body and each have a light in-coupling surface. This results in the technical advantage that the base body forwards various light signals which are coupled into the respective light in-coupling surfaces. Thus, a variety of information originating from various light sources can be displayed by the display element.

In another advantageous embodiment, the base section and the two arm sections are configured in one piece and/or materially integrally. This results in the technical advantage that light signals coupled in at the light in-coupling surfaces do not experience interruption when passing through the base body at boundaries in the form of connection surfaces, and thus optimum forwarding of light signals is ensured.

In another advantageous embodiment, the base body is made from plastic. This results in the technical advantage that the base body can be produced mechanically and hence particularly cost-effectively using known technologies from easily available materials.

In another advantageous embodiment, the base body has a latching element for fastening to the connection module. This results in the technical advantage that the base body is securely fastened to the connection module and is not undesirably released and displaced by vibrations occurring in the environment of an automation installation. Thus, operational reliability is increased.

In another advantageous embodiment, the connection module has an opening in which the display element is at least partially received. This results in the technical advantage that the base body can conduct light signals from the interior of the connection module to the operating indicator. Thus, the connection module has a particularly simple design.

In another advantageous embodiment, the connection module has a light source emitting light into the light in-coupling surface. This results in the technical advantage that light signals can be generated by the light source and can be conducted by the base body to the display element and can display various signals, for instance digital signal states, displays of input/output signal states (IO signal states), displays of diagnostic states of connected devices and/or displays of network states.

According to a second aspect, the problem is solved by a display element for such a connection module. This results in the technical advantage that light signals from a light source, which is arranged so as to be remote from the display element, can be forwarded. As a result, the design of the connection module is simplified.

According to a third aspect, the problem is solved by a labeling field element for such a display element. This results in the technical advantage that light signals from a light source, which is arranged so as to be remote from the display element, can be forwarded. As a result, the design of the connection module is simplified.

Further exemplary embodiments are explained with reference to the appended drawings, in which

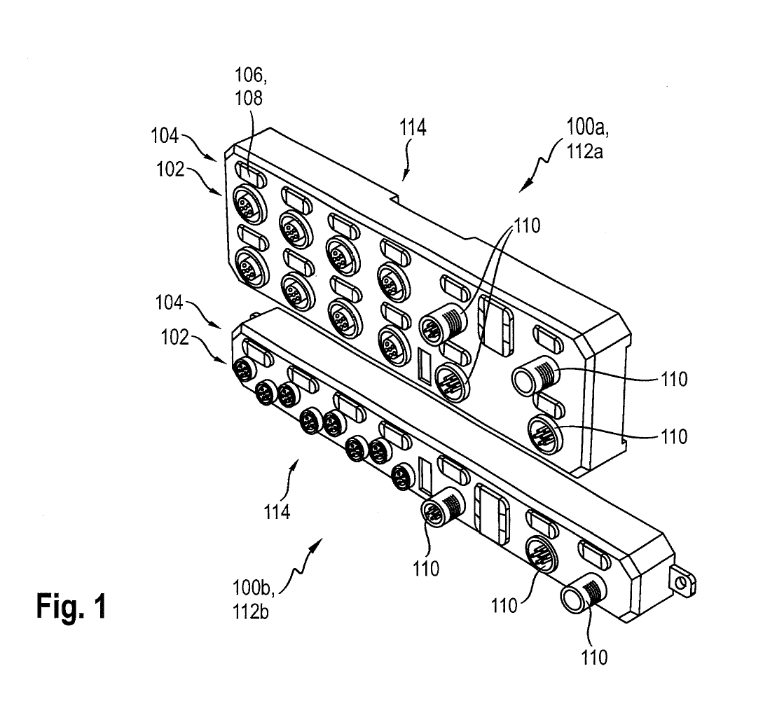

FIG. 1 shows a perspective view of two exemplary embodiments of connection modules,

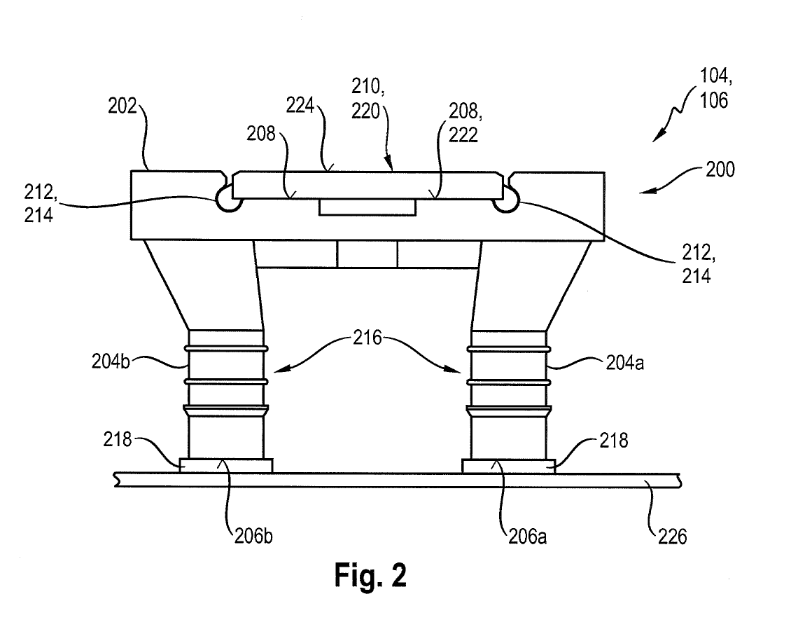

FIG. 2 shows a sectional illustration through a section of a connection module in FIG. 1,

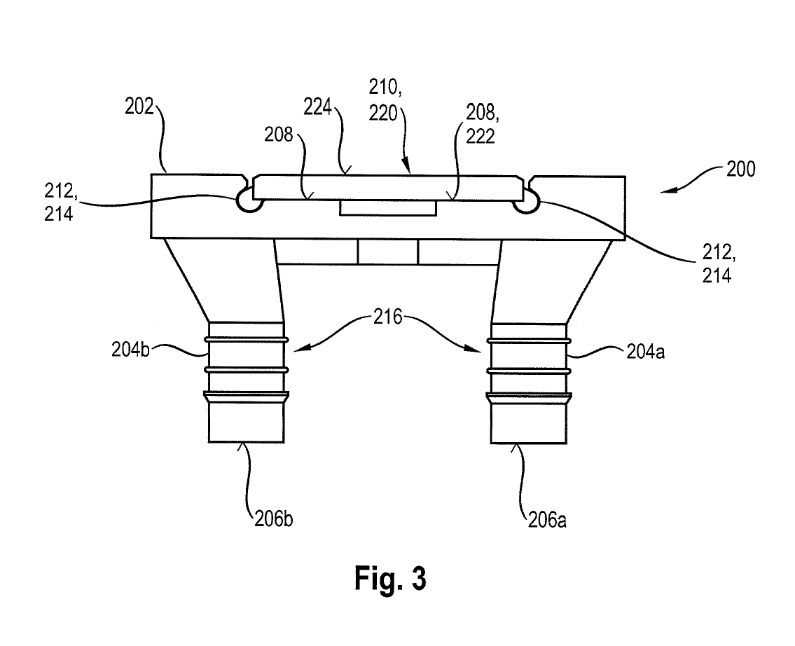

FIG. 3 shows a side view of a base body,

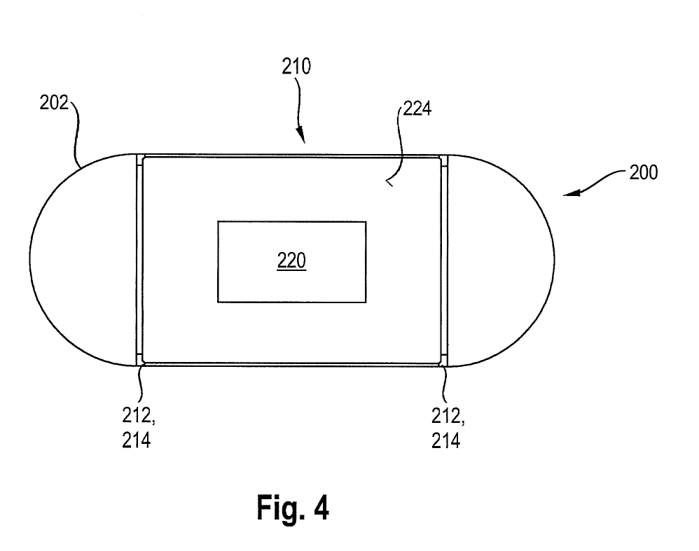

FIG. 4 shows a plan view of the base body,

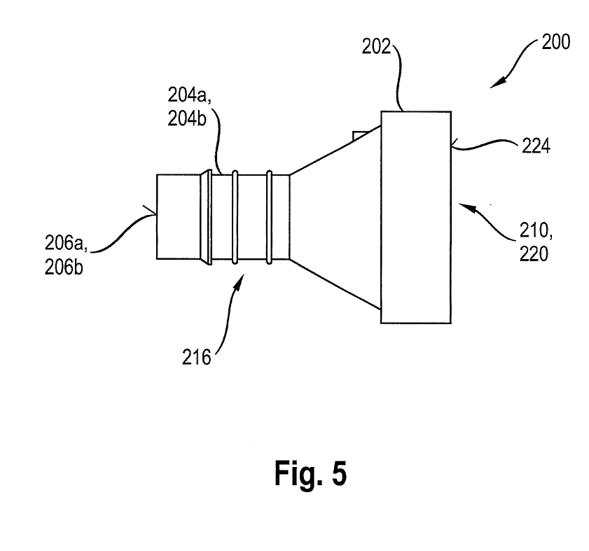

FIG. 5 shows a side view of the base body,

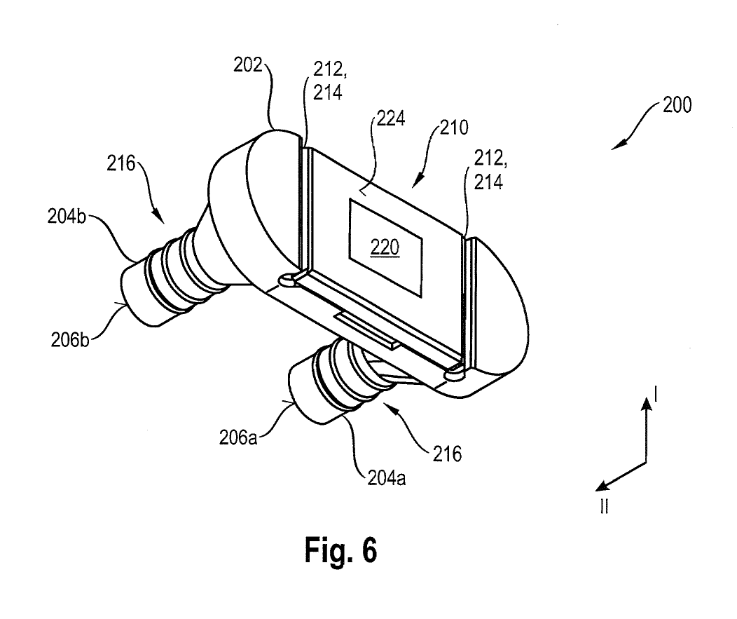

FIG. 6 shows a perspective illustration of the base body,

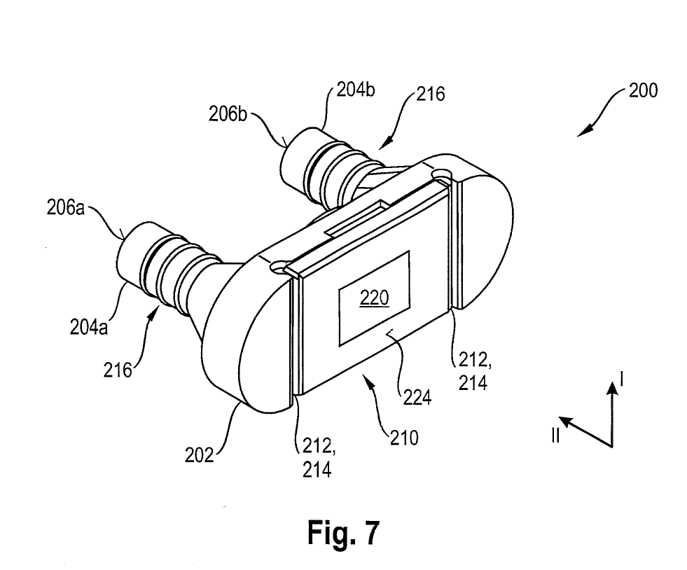

FIG. 7 shows another perspective illustration of the base body, and

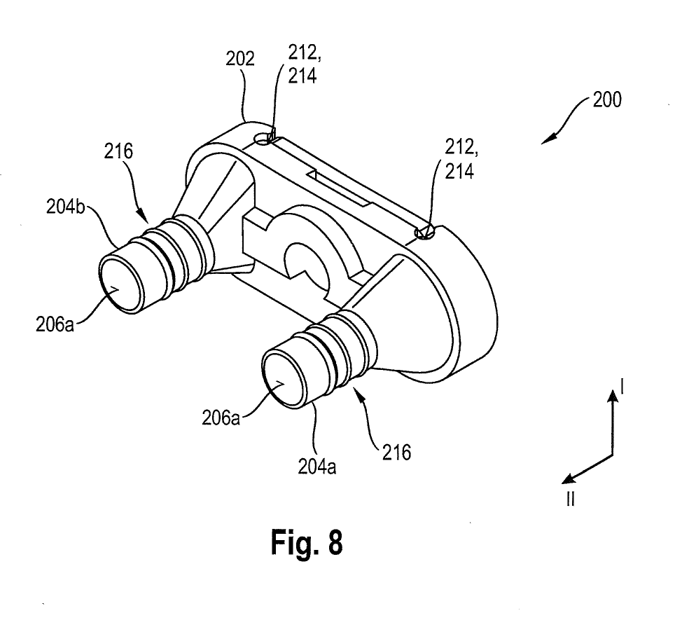

FIG. 8 shows another perspective illustration of the base body.

FIG. 1 shows a first connection module 100a and a second connection module 100b. These are input/output signal devices and/or function devices in the field of automation engineering for insertion into an automation installation.

In the present exemplary embodiment, the first connection module 100a and the second connection module 100b are configured as sensor/actuator boxes for machine-oriented signal acquisition in an automation installation.

In the present exemplary embodiment, the first connection module 100a has eight connections 102, which are configured in the present exemplary embodiment as M12 connections and enable in the present exemplary embodiment the connection of in each case one sensor or actuator as functional element to each of the connections 102. Thus, the connections 102 in the present exemplary embodiment are configured as sensor/actuator connections. Furthermore, the connection module 100a in the present exemplary embodiment has four further connections 110 of which two are configured as M12 connections in the present exemplary embodiment. Using the further connections 110, for example sensor signals can be forwarded from the connections 102 to further components of the automation installation. The further connections 110 can be, for example, a network bus connection or field bus connection, which may also be configured as socket/socket connectors, for example in the case of Ethernet-based devices. In the present exemplary embodiment, one of the further connections 110 is configured as a plug/socket field bus interface. It is possible for a connection for a voltage supply, in the present exemplary embodiment for supplying and conducting electricity, to be arranged in a second row.

In the present exemplary embodiment, the connection module 100b has eight connections 102, which are configured as M8 connections in the present exemplary embodiment and enable in the present exemplary embodiment the connection of in each case one sensor or actuator as functional element to each of the connections 102. Thus, the connections 102 are configured as sensor/actuator connections. Furthermore, the connection module 100b has three further connections 110 of which one connection is configured as M12 connection in the present exemplary embodiment. Here, too, the further connections 110 enable sensor signals to be forwarded from the connections 102 to further components of the automation installation. The further connections 110 can be, for example, a network bus connection or field bus connection, which may also be configured as sockets, for example in the case of Ethernet-based devices. In the present exemplary embodiment, one of the further connections 110 is configured as a plug of an incoming field bus interface. It is possible, in the present exemplary embodiment, for a connection for a continuing field bus or for an Ethernet interface to be arranged in a second row and for a connection for a voltage supply to be arranged in a third row.

In the present exemplary embodiment, an operating indicator 104 is assigned to each of the connections 102 and each of the further connections 110. The operating indicators 104 are used to optically signal digital signal states, to display input/output signal states, to display diagnostic states of devices of the automation installation and to display network states. Each operating device 104 has a display element 106 which is received in in each case one opening 108 of a housing 112a, 112b of the connection modules 100a, 100b. In the present exemplary embodiment, the housings 112a, 122b are impervious to dust and splashproof in order to ensure reliable operation of the connection modules 100a, 100b in an automation installation. In the present exemplary embodiment, the housings are made from plastic, for example by means of injection molding.

Furthermore, in the present exemplary embodiment, the housings 112a, 112b have stop means 114 the function of which is explained below. In the present exemplary embodiment, the stop means 114 are formed on the housings 112a, 112b. Thus, the housings 112a, 112b and the stop means 114 are configured in the present exemplary embodiment in one piece and materially integrally.

FIG. 2 shows the schematic design of the operating indicator 104 with the display element 106.

The display element 106 has a base body 200 in the present exemplary embodiment. The base body 200 comprises in the present exemplary embodiment a base section 202, a first arm section 204a and a second arm section 204b. In the present exemplary embodiment, the base body 200, comprising the base section 202 and the two arm sections 204, 204b, is made in one piece and materially integrally from an optically transparent plastic. However, the base body 200 may be optically colored, either completely or only in sections, in order to provide colored light.

The first arm section 204a has a first light in-coupling surface 206a, and the second arm section 204b has a second light in-coupling surface 206b. The first light in-coupling surface 206a is in contact with a light source 218 which is arranged on a circuit board 226 arranged in the interior of the connection module 100a, 100b. Furthermore, the second light in-coupling surface 206b is in contact with another light source 218 which is likewise arranged on the circuit board 226. In the present exemplary embodiment, the light source 218 is configured as an LED. Thus, light signals from the two light sources 218 can be coupled into the base body 200 through the two light in-coupling surfaces 206a, 206b.

The base section 202 of the base body 200 has a light out-coupling surface 208, wherein the first arm section 204a and the second arm section 204b join in the base section 202, with the result that light signals are guided from the first light in-coupling surface 206a at the first arm section 204a and/or from the second light in-coupling surface 206b at the second arm section to the light out-coupling surface 208.

The light out-coupling surface 208 of the base section 202 of the base body 200 is in contact with a labeling-field light in-coupling surface 220 of a labeling field element 210. Thus, light signals can be coupled into the labeling field element 210 from the light out-coupling surface 208 through the labeling-field light in-coupling surface 220, which labeling field element in turn has a labeling-field light out-coupling surface 224 for outputting the light signals.

The labeling field element 210 in the present exemplary embodiment is made from plastic, for example clear plastic. However, it may also be made from colored plastic. The labeling field 210 in the present exemplary embodiment has a guide section 212 which is in engagement with a guide 214 of the base body 200. In the present exemplary embodiment, the guide 214 is arranged in the base section 202. Furthermore, in the present exemplary embodiment, the guide 214 is configured as slot and the guide section 212 is configured as sliding block. The labeling field element 210 is fastened securely to the base body 200 by the guide section 212 engaging in the guide 214. In the present exemplary embodiment, the guide section 212 is formed in one piece on the labeling field element 210.

The labeling field element 210 in the present exemplary embodiment has a labeling 220 which displays information about, for example, the functional element which is connected to the connection 102. The labeling 220 can be applied to the labeling field element 210 by pressing-on or by surface-material removal, for example by milling or by laser treatment.

Finally, the base body 200 in the present exemplary embodiment has latching elements 216 which are arranged on the two arm sections 204, 205 and, in the present exemplary embodiment, are configured as rings surrounding the two arm sections 204a, 204b which dip into the opening 108 and latch there with correspondingly configured opening sections in order to securely fasten the display element 106 to the connection module 100a, 100b.

FIGS. 3 to 5 show the base body 200 with the base section 202, the two arm sections 204a, 204b and with the labeling field element 210 fastened to the base body 200 in a side view, a plan view and another side view.

FIGS. 6 to 8 show the base body 200, the base section 202 and the arm sections 204a, 204b with the attached labeling field element 210 in various perspective illustrations.

FIGS. 6 to 8 also show that the guide section 212 and the guide 214 define a first mounting direction I, with the result that the labeling field element 210 can be fastened to the base body 200 by displacing the labeling field element 210 in this direction. For this purpose, it is necessary first to bring the guide 214 into engagement with the guide section 212. By displacement in a second mounting direction II, the base body 200 is then fastened with the labeling field element 210 to the connection module 100a, 100b by the two arm sections 206a, 204b being displaced into the opening 108 in the direction of the second mounting direction II.

If the base body 200 with the labeling field element 210 has reached its end position in the opening 108, what is achieved by the corresponding configuration of the opening 108 is that a displacement of the labeling field element 210 in the guide 214 in the mounting direction I is blocked by stop means 114, for example an edge surrounding the opening 108. Thus, the labeling field element 210 cannot undesirably fall out or be released. Since in the present exemplary embodiment the first mounting direction I runs at right angles to the second mounting direction II, a particularly simple, intuitive mounting is given.

During operation, light signals from the light sources 218 on the circuit board 226 are coupled in through the two light in-coupling surfaces 206a, 206b to the arm sections 204a, 204b and forwarded to the base section 204 of the base body 200. Then, the light signals emerge out of the light out-coupling surfaces 208 and enter through the labeling-field light in-coupling surface 220 into the labeling field element 210, where they emerge again through the labeling-field light out-coupling surface 224 and illuminate a labeling 220.

The operating indicator 104 is used in the present exemplary embodiment to optically signal digital signal states, to display input/output signal states, to display diagnostic states of devices of the automation installation and to display network states.

By displacement in a second mounting direction II, the base body can be removed, and by displacement in the direction of the first mounting direction, the labeling field element 210 can be removed, for example in order to change or amend the labeling 220 or to replace the labeling field element 210 with another labeling field element 210 with another labeling 220. Thus, simple adaption to changes is possible.

### LIST OF REFERENCE SIGNS

100a connection module

100b connection module

102 connection

104 operating indicator

106 display element

108 opening

110 further connection

112a housing

112b housing

114 stop means

200 base body

202 base section

204a arm section

204b arm section

206a light in-coupling surface

206b light in-coupling surface

208 light out-coupling surface

210 labeling field element

212 guide section

214 guide

216 latching element

218 light source

220 labeling

222 labeling-field light in-coupling surface

224 labeling-field light out-coupling surface

226 circuit board

I first mounting direction

II second mounting direction

1. A connection module with a plurality of connections for functional elements and with a plurality of operating indicators, wherein at least one of the operating indicators has a display element, and wherein the display element has a base body which is configured as a light guide and which has a light in-coupling surface and a light out-coupling surface.

2. The connection module as claimed in claim 1, wherein the display element has a labeling field element.

3. The connection module as claimed in claim 2, wherein the labeling field element has a labeling-field light in-coupling surface and wherein the labeling-field light in-coupling surface is in light-conductive contact with the light out-coupling surface.

4. The connection module as claimed in claim 2, wherein the labeling field element has a labeling.

5. The connection module as claimed in claim 2, wherein the labeling field element has a guide section which is in engagement with a guide of the base body.

6. The connection module as claimed in claim 5, wherein the guide section and the guide define a first mounting direction for mounting the labeling field element on the base body, wherein the first mounting direction differs from a second mounting direction for mounting the display element on the connection module.

7. The connection module as claimed in claim 6, wherein the first mounting direction and the second mounting direction are arranged at right angles to one another.

8. The connection module as claimed in claim 1, wherein the base body has a base section with the light out-coupling surface and at least two arm sections which adjoin the base body and each have a light in-coupling surface.

9. The connection module as claimed in claim 8, wherein the base section and the two arm sections are configured in one piece and/or materially integrally.

10. The connection module as claimed in claim 1, wherein the base body is made from plastic.

11. The connection module as claimed in claim 1, wherein the base body has a latching element for fastening to the connection module.

12. The connection module as claimed in claim 1, wherein the connection module has an opening in which the display element is at least partially received.

13. The connection module as claimed in claim 1, wherein the connection module has a light source emitting light signals into the light in-coupling surface.

14. A display element for a connection module as claimed in claim 1.

15. A labeling field element for a display element as claimed in claim 14.

16. The connection module as claimed in claim 3, wherein the labeling field element has a labeling.

17. The connection module s claimed in claim 4, wherein the labeling field element has a guide section which is in engagement with a guide of the base body.

18. The connection module as claimed in claim 5, wherein the base body has a base section with the light out-coupling surface and at least two arm sections which adjoin the base body and each have a light in-coupling surface.

19. The connection module as claimed in claim 8, wherein the base body is made from plastic.

20. The connection module as claimed in claim 9, wherein the base body has a latching element for fastening to the connection module.
